(19) United States
(12) Patent Application Publication
(10) Pub. No.: US 2015/0186918 A1
(43) Pub. Date: Jul. 2, 2015

(54) SYSTEMS AND METHODS FOR AUTOMATIC REWARD REDEMPTION

(71) Applicant: Capital One Financial Corporation, McLean, VA (US)

(72) Inventor: Thomas Christopher CLARKE, Arlington, VA (US)

(73) Assignee: CAPITAL ONE FINANCIAL CORPORATION, McLean, VA (US)

(21) Appl. No.: 14/563,478

(22) Filed: Dec. 8, 2014

Related U.S. Application Data
(60) Provisional application No. 61/922,147, filed on Dec. 31, 2013.

(51) Int. Cl. G06Q 30/02; G06Q 20/40; G06Q 20/24; G06Q 20/38

(52) U.S. Cl. CPC G06Q 30/0233; G06Q 30/0222; G06Q 20/387; G06Q 20/40; G06Q 20/24

(57) ABSTRACT

Systems and methods are provided for enrolling a customer into a rewards program and allowing the customer to conveniently redeem reward benefits. Consistent with certain embodiments, computer-implemented systems and methods are provided for enrolling a customer into a rewards program. Enrolling the customer may include verifying the customer's credentials and allowing the customer to select categories of transactions and/or specific merchants for redeeming the reward benefits. Additionally, systems and methods are provided for redeeming the reward benefits. Consistent with certain embodiments, computer-implemented systems and methods are provided for determining the number of reward points or miles corresponding to cost of the transaction. Additionally, systems and methods are provided for crediting the account with the cost of the transaction. Systems and methods are also provided for determining a partial cash value for the credit when the reward balance is insufficient to cover the cost of the transaction.

### CROSS-REFERENCE TO RELATED APPLICATION

This application is entitled to and claims the benefit of priority from U.S. Provisional Application No. 61/922,147 (Attorney Docket no. 05793.6110-00000) by Chris CLARKE, filed Dec. 31, 2013, the contents of which are expressly incorporated herein by reference.

### BACKGROUND

Consumers can avail themselves of a variety of financial services provided by an ever increasing number of providers, including banks, credit unions, credit card issuers, and merchants, both online and through traditional brick and mortar outlets. Keen to capture a bigger slice of the consumer market, providers often offer incentive or rewards programs to persuade consumers to choose their services over those of other providers.

A rewards program from a provider allows a customer to earn reward benefits, such as, reward points, reward miles, and/or reward currency when the customer purchases goods and/or services using a method of payment authorized by the provider. For example, a customer may earn reward points, reward miles, and/or reward currency when the customer uses a credit, debit, or reward card provided by a bank, credit union, credit card issuer, or a merchant to purchase goods or services. The customer has the option of using the reward points, reward miles, and/or reward currency to pay for any outstanding amount of credit associated with the customer's account. In some instances, the customer may also redeem the reward points, reward miles, and/or reward currency to obtain a voucher or a card that could be used to pay for a subsequent purchase at a specific merchant. In most instances, the customer must access his or her account via a web site or by contacting the provider to request redemption of any reward benefits associated with the account.

Rewards programs do not typically allow a consumer to access reward benefits to pay for a pending purchase unless the consumer has previously requested the provider to redeem the reward benefits. As a result, consumers are either unaware of the reward benefits provided by the rewards program or simply forget to use their accrued reward benefits. The provider in turn must carry the unused reward benefits of all its customers as a liability on its financial records. Providers, therefore, have an incentive to make it easy for their customers to use accumulated reward benefits to reduce the amount of the liability and to incentivize customers to continue to use the provider's services preferentially over those of competing providers. Currently, however, no easy to use system and/or method exists to allow a customer to conveniently redeem accumulated reward benefits at the time of purchase of goods and services.

In view of the above deficiencies, there exists a need for improved systems and methods for providing customers with a convenient way to redeem their reward benefits. Further, there exists a need for improved systems and methods for informing a customer about the availability of reward benefits for a purchase at the time the customer makes that purchase. Additionally, there exists a need for improved systems and methods to allow customers to decide whether or not to partially or fully apply their accumulated reward benefits towards a particular purchase. There also exists a need for improved systems and methods for notifying the customer about the amount of reward benefits used towards a particular purchase.

### SUMMARY

In accordance with the present disclosure, systems and methods are provided for informing a customer about reward benefits available to cover some or all of the cost of a pending purchase at the time the customer makes that purchase. In accordance with certain embodiments, systems and methods are provided for providing a customer with a convenient way to redeem the reward benefits to cover some or all of the cost of a purchase. Embodiments of the present disclosure may also provide systems and methods to allow a customer to determine whether or not to redeem reward benefits for a particular purchase. Embodiments of the present disclosure may further provide systems and methods for notifying a customer of the amount reward benefits applied towards the cost of a purchase.

In accordance with one exemplary embodiment, a computer-implemented method is disclosed for reward redemption. By way of example, the method comprises receiving an indication that a customer initiated a transaction, determining a cost of the transaction, determining, by one or more processors, eligibility of the transaction for reward redemption, and when the transaction is eligible, debiting the cost of the transaction minus a credit from an account associated with the customer, sending a notification to the customer regarding the credit, and authorizing completion of the transaction.

In accordance with another exemplary embodiment, a system for reward redemption is disclosed. By way of example, the system comprises a database, a memory storing instructions, and at least one processor configured to execute the instructions to perform operations comprising receiving an indication that a customer initiated a transaction, determining a cost of the transaction, accessing information for an account associated with a customer from the database, determining eligibility of the transaction for reward redemption, and when the transaction is eligible, debiting the cost minus a credit from the account, storing information related to the credit in the database, sending a notification indicating the credit to the customer, and authorizing completion of the transaction.

In accordance with another exemplary embodiment, non-transitory computer-readable medium storing instructions for creating a logo database is disclosed. The instructions, when executed by a processor, cause the computer to perform the steps of receiving an indication that a customer initiated a transaction, determining a cost of the transaction, determining eligibility of the transaction for reward redemption, and when the transaction is eligible, debiting the cost of the transaction minus a credit from an account associated with the customer, sending a notification to the customer indicating the credit, and authorizing completion of the transaction.

Additional objects and advantages of the embodiments of the present disclosure will be set forth in part in the description which follows, and in part will be obvious from the description, or may be learned by practice of the embodiments of the present disclosure.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this present disclosure, illustrate disclosed embodiments of the present disclosure and, together with the description, serve to explain the principles of the present disclosure. In the drawings:

FIG. 1 shows an exemplary system consistent with disclosed embodiments;

FIG. 2 shows a block diagram of another exemplary system consistent with disclosed embodiments;

FIG. 3 shows an exemplary process of enrolling a customer in a rewards program consistent with disclosed embodiments;

FIG. 4 shows an exemplary process of applying reward benefits to cover the cost of a transaction consistent with disclosed embodiments; and

FIG. 5 shows an exemplary process of determining a reward amount to cover the cost of a transaction consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts. The disclosed embodiments include methods and systems configured to provide, for example, convenient redemption of reward benefits for a customer.

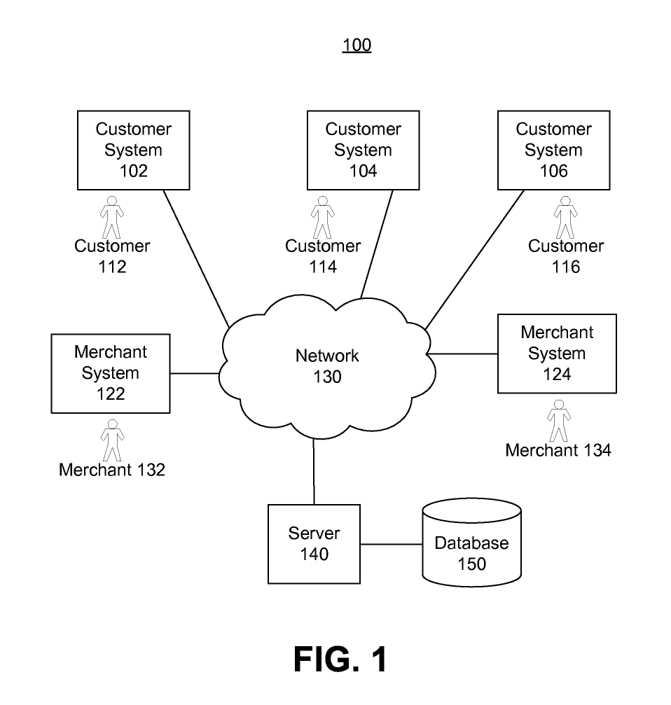

FIG. 1 shows a block diagram of an exemplary system 100 for implementing embodiments and features of the present disclosure. The arrangement and number of components in system 100 is provided for purposes of illustration. Additional arrangements, number of components, and other modifications may be made, consistent with the present disclosure.

As shown in FIG. 1, in one embodiment, system 100 may include one or more customer systems 102, 104, 106. By way of example, customer systems 102, 104, 106 may include smartphones, tablets, netbooks, electronic readers, personal digital assistants, personal computers, laptop computers, desktop computers, and/or other types of electronics or communication devices. In certain embodiments, customer systems 102, 104, 106 may be configured to be operated by customers 112, 114, 116, respectively, to communicate to and/or through network 130 with other components, such as merchant systems 122, 124, server 140, and/or database 150. In certain embodiments customer systems 102, 104, 106 may be operated by one or more customers 112, 114, 116 to perform transactions, for example, purchasing goods and services using accounts associated with credit cards, debit cards, rewards cards, etc. authorized by one or more providers. As used in this disclosure, a provider may include, for example, a bank, a credit union, a credit card issuer, a merchant and/or any other entity providing a line of credit and/or other financial services.

Merchant systems 122, 124 may include point-of-sale terminals, tablets, personal digital assistants, personal computers, laptop computers, desktop computers, smartphones, netbooks and/or other types of electronics or communication devices. Merchant systems 122, 124 may be configured to be operated by one or more merchants 132, 134, respectively, or by one or more customers 112, 114, 116 to and/or through network 130 to communicate with other components, such as customer systems 102, 104, 106, server 140, and/or database 150. In certain embodiments, merchant systems 122, 124 may be configured to facilitate and/or perform transactions, for example, sale of goods and/or services to one or more customers 112, 114, 116.

System 100 may also include network 130 which may facilitate communications between the customer systems 102, 104, 106, customers 112, 114, 116, merchant systems 122, 124, merchants 132, 134, server 140, and/or databases 150. In certain embodiments, network 130 may include any combination of communications networks. For example, network 130 may include the Internet and/or any type of wide area network, an intranet, a metropolitan area network, a local area network (LAN), a wireless network, a cellular communications network, etc.

Server 140 may include one or more servers configured to communicate and interact with customer systems 102, 104, 106, merchant systems 122, 124, network 130, and/or database 150. In one exemplary embodiment, server 140 may belong to a merchant or financial services provider and may implement or provide one or more web services, online market services, financial transaction engines, and/or financial models for facilitating the sale of goods and/or services to one or more customers 112, 114, 116. In another exemplary embodiment, server 140 may facilitate initiating, recording, updating, and/or modifying financial transaction data, etc., for a transaction including the sale of goods and/or services to one or more customers 112, 114, 116. In yet another exemplary embodiment, server 140 may help to create, maintain, update, and/or modify one or more accounts associated with one or more customers 112, 114, 116. In another exemplary embodiment, server 140 may also help to enroll customers 112, 114, 116 in a rewards program and to create, maintain, update, and/or modify reward benefits associated with the one or more accounts associated with the enrolled customers 112, 114, 116.

Server 140 may be a general-purpose computer, a mainframe computer, or any combination of these components. In certain exemplary embodiments, server 140 may be a standalone computing system or apparatus, or it may be part of a subsystem, which may be part of a larger system. For example, server 140 may represent distributed servers that are remotely located and communicate over a communications medium (e.g., network 130) or over a dedicated network, for example, a LAN. Server 140 may be implemented as a server, a server system comprising a plurality of servers, or a server farm comprising a load balancing system and a plurality of servers.

Database 150 may include one or more logically and/or physically separate databases configured to store data. The data stored in database 150 may be received from servers 140, from customer systems 102, 104, 106, from merchant systems 122, 124 and/or may be provided as input using conventional methods (e.g., data entry, data transfer, data uploading, etc.). The data stored in database 150 may include credentials, credit history, transaction history, information related to the enrollment in and use of a rewards program, reward balance, information related to one or more accounts, and/or other financial data associated with one or more customers 112, 114, 116. Additionally or alternatively, the data stored in the database 150 may take or represent various forms including, but not limited to, documents, presentations, textual content, mapping and geographic information, rating and review information, pricing information, news, audio files, video files, and a variety of other electronic data, or any combination thereof.

In some embodiments, database 150 may be implemented using a single computer-readable storage medium. In other embodiments, database 150 may be maintained in a network attached storage device, in a storage area network, or combinations thereof, etc. Furthermore, database 150 may be maintained and queried using numerous types of database software and programming languages, for example, SQL, MySQL, Mongo DB, IBM DB2®, Microsoft Access®, PERL, C/C++, Java®, etc. Although FIG. 1 shows database 150 associated with server 140, database 150 may be a standalone database that is accessible via network 130 or database 150 may be associated with or provided as part of a system or environment that may be accessible to customer systems 102, 104, 106, merchant systems 122, 124 and/or other components.

The components and arrangement of the components included in system 100 may vary. Thus, system 100 may further include other components that perform or assist in the performance of one or more processes consistent with the disclosed embodiments. Further, system 100 may include any number of customer systems 102, 104, 106, customers 112, 114, 116, merchant systems 122, 124, merchants 132, 134, server systems 140, and/or databases 150. In some exemplary embodiments, customers 112, 114, 116 may employ customer systems 102, 104, 106 and/or merchant systems 122, 124 to perform one or more functions.

Although the above description presents exemplary functions performed by one or more of customer systems 102, 104, 106, merchant systems 122, 124, and/or server 140, in some exemplary embodiments, the functions performed by customer systems 102, 104, 106 may interchangeably be performed by merchant systems 122, 124 and/or server 140. In other exemplary embodiments, the functions performed by merchant systems 122, 124 may interchangeably be performed by customer systems 102, 104, 106, and/or server 140. In yet other exemplary embodiments, the functions performed by server 140 may interchangeably be performed by customer systems 102, 104, 106, and/or merchant systems 122, 124.

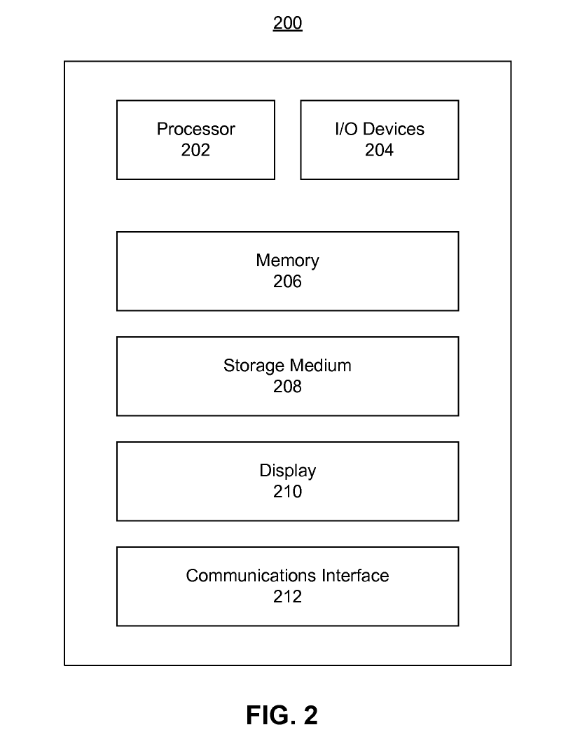

FIG. 2 illustrates an exemplary electronic apparatus or system 200 for implementing embodiments and features of the present disclosure. By way of example, apparatus or system 200 may be used to implement customer systems 102, 104, 106, merchant systems 122, 124, and/or server 140 of system 100. The arrangement and number of components in system 200 are provided for purposes of illustration. Additional arrangements, number of components, and other modifications may be made, consistent with the present disclosure.

System 200 may include one or more processors 202 for executing instructions. System 200 may also include one or more input/output (I/O) devices 204. By way of example, I/O devices 204 may include physical keyboards, virtual touch-screen keyboards, mice, joysticks, styluses, etc. In certain exemplary embodiments, I/O devices 204 may include a microphone (not shown) for providing input to system 200 using, for example, voice recognition, speech-to-text, and/or voice command applications. In other exemplary embodiments, I/O devices 204 may include a telephone keypad and/or a keypad on a touch-screen for providing input to system 200. In yet other exemplary embodiments, input may be provided to system 200 in the form of spoken information provided by customer 112, 114, 116 to a customer services representative or an operator associated with system 200.

As further illustrated in FIG. 2, system 200 may include memory 206 configured to store data or one or more instructions and/or software programs that perform functions or operations when executed by the one or more processors 202. By way of example, memory 206 may include Random Access Memory (RAM) devices, NOR or NAND flash memory devices, Read Only Memory (ROM) devices, etc. System 200 may also include storage medium 206 configured to store data or one or more instructions and/or software programs that perform functions or operations when executed by the one or more processors 202. In some exemplary embodiments, storage medium 206 may also be configured to store By way of example, storage medium 208 may include hard drives, solid state drives, tape drives, RAID arrays, compact discs (CDs), digital video discs (DVDs), Blu-ray discs (BD), etc. Although FIG. 2 shows only one memory 206 and one storage medium 208, system 200 may include any number of memories 206 and storage mediums 208. Further, although FIG. 2 shows memory 206 and storage medium 208 as part of system 200, memory 206 and/or storage medium 208 may be located remotely and system 200 may be able to access memory 206 and/or storage medium 208 via network 130.

System 200 may also include one or more displays 210 for displaying data and information. Display 210 may be implemented using devices or technology, such as a cathode ray tube (CRT) display, a liquid crystal display (LCD), a plasma display, a light emitting diode (LED) display, a touch screen type display, a projection system, and/or any other type of display known in the art.

System 200 may also include one or more communications interfaces 212. Communications interface 212 may allow software and/or data to be transferred between system 200, network 130, customer systems 102, 104, 106, merchant systems 122, 124, server 140, and/or other components. Examples of communications interface 212 may include a modem, a network interface (e.g., an Ethernet card or a wireless network card), a communications port, a PCMCIA slot and card, a cellular network card, etc. Communications interface 212 may transfer software and/or data in the form of signals, which may be electronic, electromagnetic, optical, or other signals capable of being transmitted and received by communications interface 212. Communications interface 212 may transmit or receive these signals using wire, cable, fiber optics, radio frequency (“RF”) link, and/or other communications channels.

The disclosed embodiments are not limited to separate programs or computers configured to perform dedicated tasks. For example, server 140 may include memory 206 that stores a single program or multiple programs. Additionally, server 140 may execute one or more programs located remotely from server 140. For example, server 140 may access one or more remote programs stored in memory 206 included within a component, for example, customer system 102, 104, or 106, or merchant system 122 or 132 that, when executed, perform operations consistent with the disclosed embodiments. In some exemplary embodiments, server 140 may be capable of accessing separate web server(s) or computing devices that generate, maintain, and provide web site(s), online market services, financial transaction engines and/or financial models. Customer systems 102, 104, 106 may function in a manner similar to server 140 and vice-versa. Customer systems 102, 104, 106 may also function in a manner similar to merchant systems 122, 124 and vice-versa. Merchant systems 122, 124 may also function in a manner similar to server 140 and vice-versa.

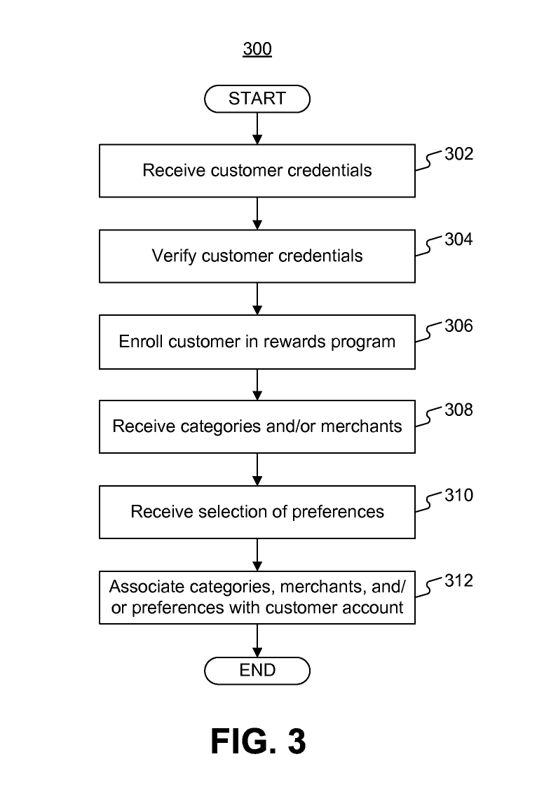

FIG. 3 is a flowchart of an exemplary process 300 that may be implemented for enrolling one or more customers 112, 114, 116 into a rewards program. Process 300 may be implemented on customer systems 102, 104, 106, merchant systems 122, 124, and/or server 140 with or without communications via network 130. The order and arrangement of steps in process 300 is provided for purposes of illustration. As will be appreciated from this disclosure, modifications may be made to process 300 by, for example, adding, combining, removing, and/or rearranging the steps for process 300.

As shown in FIG. 3, process 300 may include a step 302 of receiving customer credentials. Customer credentials may include, for example, a customer identifier, a password, a personal identification number (PIN), an identifier corresponding to an account associated with the customer, a photograph, biometric information such as a retinal scan, fingerprint, etc., and/or other credentials corresponding to the customer. An account associated with the customer may include, for example, a credit or debit card account, a revolving credit account, a bank account, an investment account, a rewards account, etc. Receiving customer credentials in step 302 may include accessing customer credentials stored in database 150 or in another database associated with system 100. In some exemplary embodiments, receiving customer credentials may include accessing customer credentials stored in memory 206 or storage medium 208. In other exemplary embodiments, customer credentials may be received when customer 112, 114, 116 inputs or provides the credentials using one or more of the I/O devices 204 or by reciting the credentials, using a telephone, to a customer services representative or an operator associated with system 100.

Process 300 may also include a step 304 of verifying customer credentials received, for example, in step 302. Verifying customer credentials may include, for example, determining whether the customer identifier, password, PIN, signature, photograph, biometric information, and/or other credential is valid. Determining whether the customer credentials are valid may include, for example, comparing the customer credentials with credential information, stored in association with the customer, in database 150, memory 206, and/or storage medium 208. In some exemplary embodiments, customer credentials may be deemed verified, for example, when the customer credentials substantially match the credential information, stored in association with the customer, in database 150, memory 206, and/or storage medium 208. Additionally or alternatively, in some exemplary embodiments, the customer may be asked to provide an answer to a security or challenge question. In such exemplary embodiments, customer credentials may be deemed verified when the answer provided by the customer in response to the security or challenge question substantially matches a response, stored in association with the customer, in database 150, memory 206, and/or storage medium 208.

Process 300 may also include a step 306 of enrolling a customer in a rewards program. Enrolling the customer may include providing the customer with information regarding the rewards program. In one exemplary embodiment, information regarding the rewards program may be presented to customer 112, 114, 116 by displaying the information on display 210 associated with customer system 102, 104, 106, merchant system 122, 124, server 140, and/or any other device or component being used by customer 112, 114, 116. In another exemplary embodiment, the information regarding the rewards program may be presented to customer 112, 114, 116 in the form of a printout, an audio recording, or by reciting the information to customer 112, 114, 116. In yet another exemplary embodiment, the information regarding the rewards program may be sent to customer 112, 114, 116 as a notification. A notification may be sent to customer 112, 114, 116 via electronic mail (e-mail), text message, short message service (SMS), voice mail, and/or regular postal mail. Sending a notification to customer 112, 114, 116 may also include displaying messages to customer 112, 114, 116 on a web site provided by a provider of the rewards program.

Information regarding the rewards program may include information about how customer 112, 114, 116 may accumulate and/or redeem reward benefits. As used in this disclosure, reward benefits may include, as non-limiting examples, reward points, reward miles, reward currency, and/or a cash value. Further, customer 112, 114, 116 may accumulate reward benefits by making purchases using a method of payment authorized by a provider offering the rewards program.

Enrolling customer 112, 114, 116 in the rewards program in step 306 may also include giving customer 112, 114, 116 an option to accept or decline such enrollment. When customer 112, 114, 116 agrees to enroll in the rewards program, a flag, an indicator, or any other type of marker known in the art may be used to mark the customer's account to identify the account as an account that has been enrolled in the rewards program. Further, enrolling customer 112, 114, 116 in the rewards program may include sending a notification to customer 112, 114, 116 using any of the methods of sending a notification discussed above.

As illustrated in FIG. 3, process 300 may also include a step 308 of receiving a selection of categories and/or merchants. In step 308, customer 112, 114, 116 enrolled in the rewards program may be able to select via, for example, customer system 102, 104, 106, a category to associate with an account associated with customer 112, 114, 116. As used in this disclosure, a category may refer to a category of merchants or providers. A category may also include, for example, travel, coffee, food, clothing, books, music, leisure, retail, etc. In some embodiments, selectable categories may be pre-defined by a provider offering the rewards program, such as a provider associated with server 140. Additionally or alternatively, a category may be defined by customer 112, 114, 116 via, for example, customer systems 102, 104, 106. Associating a category with the customer's account may allow customer 112, 114, 116 to accumulate and/or redeem reward benefits when customer 112, 114, 116 completes a transaction of a type falling within a selected category, such as a purchase of goods or services, using the account at a merchant or provider associated with one of the selected categories. For example, when the customer selects “coffee” as a category, the customer may accumulate or redeem reward benefits when the customer uses the account to make a purchase of, for example, coffee at a merchant or provider who sells coffee. Similarly, for example, when the customer selects “travel” as a category, the customer may accumulate or redeem reward benefits when the customer uses the account to make a purchase of, for example, an airline ticket, a car rental, a cruise ship ticket, etc., at a merchant or travel agent who sells travel related goods or services.

Additionally or alternatively, in step 308, customer 112, 114, 116 enrolled in the rewards program, may also be able select a merchant or provider to associate with the customer's account. Associating a merchant or provider with the customer's account may allow customer 112, 114, 116 to accumulate and/or redeem reward benefits when customer 112, 114, 116 completes a transaction, such as a purchase of goods or services, using the account at that merchant or provider. For example, when customer 112, 114, 116 selects, for example, “XYZ Stores” for association with the customer's account, customer 112, 114, 116 may accumulate or redeem reward benefits when customer 112, 114, 116 makes a purchase of goods and services at “XYZ Stores” using the customer's account.

As further illustrated in FIG. 3, process 300 may also include a step 310 of receiving a selection of preferences. Preferences may include customer preferences, for example, a method of receiving notifications. For example, in step 310, customer 112, 114, 116 may select via, for example, customer systems 102, 104, 106, e-mail as the method of receiving notifications. Preferences may also include, for example, customer 112, 114, 116 specifying that reward benefits may be redeemed only when a reward balance associated with the customer's account exceeds a cost of a transaction initiated by the customer. In some exemplary embodiments, preferences may include customer 112, 114, 116 specifying whether rewards benefits may be redeemed automatically or whether redeeming reward benefits requires obtaining permission from customer 112, 114, 116. In some exemplary embodiments, preferences may include customer 112, 114, 116 specifying via, for example, customer systems 102, 104, 106, that reward benefits may be redeemed to partially cover the cost of the transaction when the reward balance is insufficient to cover the total cost of the transaction. Preferences may include, for example, customer 112, 114, 116 selecting specific merchants or categories for which reward benefits may be redeemed. In some exemplary embodiments, preferences may also include customer 112, 114, 116 specifying, for example, a threshold reward balance such that customer 112, 114, 116 receives a notification when the reward balance falls below the threshold reward balance. In other exemplary embodiments, preferences may include customer 112, 114, 116 specifying the fonts, font sizes, and/or color scheme to be used for the notifications sent to customer 112, 114, 116.

Process 300 may also include a step 312 of associating categories, merchants, and/or preferences received, for example, in steps 308 and 310 with a customer account. Associating categories, merchants, and/or preferences may include storing the categories, merchants, and/or preferences in association with the customer account in memory 206, storage medium 208, database 150, and/or any other database associated with system 100. In some exemplary embodiments, associating categories, merchants, and/or preferences may include storing one or more flags, indicators or other markers representing categories, merchants, and/or preferences in association with the customer account in memory 206, storage medium 208, database 150, and/or any other database associated with system 100.

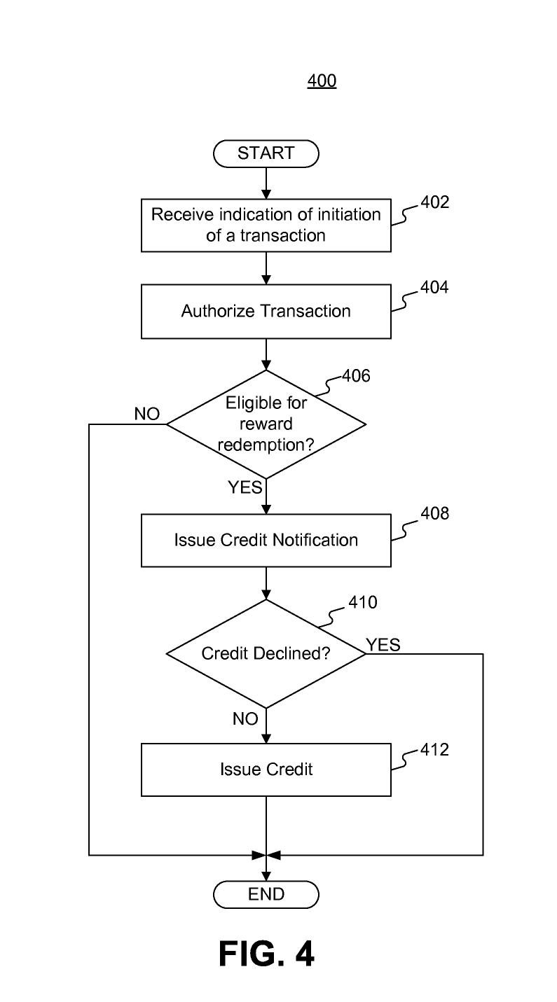

FIG. 4 is a flowchart of an exemplary process 400 that may be implemented for conveniently redeeming reward benefits accumulated by one or more customers 112, 114, 116. Process 400 may be implemented on customer systems 102, 104, 106, merchant systems 122, 124, and/or server 140 with or without communications via network 130. The order and arrangement of steps in process 400 is provided for purposes of illustration. As will be appreciated from this disclosure, modifications may be made to process 400 by, for example, adding, combining, removing, and/or rearranging the steps for process 400.

As shown in FIG. 4, process 400 may include a step 402 of receiving an indication that customer 112, 114, 116 has initiated a transaction, which may include, for example, receiving an indication that customer 112, 114, 116 is purchasing goods or services using a credit card, a debit card, a rewards card, or other payment method associated with an account associated with customer 112, 114, 116. In one exemplary embodiment, receiving an indication may include receiving an indication that customer 112, 114, 116 has swiped a credit card, debit card, rewards card, etc., at a point-of-sale terminal or other device to purchase goods and/or services.

Process 400 may also include a step 404 of authorizing the transaction initiated, for example, in step 402. Authorizing the transaction may include inspecting the customer's account. In one exemplary embodiment, authorizing the transaction may include determining whether the customer's account is in good standing. Determining good standing may include determining whether the account is overdue and whether pending charges on the account have been timely paid by customer 112, 114, 116. For example, the transaction may not be authorized or rewards may not become awarded and/or redeemed for the transaction if the account has not been timely paid or if customer 112, 114, 116 has not paid a minimum required amount to cover the pending charges on the account. In another exemplary embodiment, authorizing the transaction may include determining whether the transaction will cause the account to exceed a credit limit extended to customer 112, 114, 116. For example, the transaction may be authorized only when the transaction will not cause a credit limit associated with the account to be exceeded. In yet another exemplary embodiment, authorizing the transaction may include determining whether a fraud flag is associated with the account or transaction. For example, the transaction may not be authorized if it is determined that the transaction initiated by customer 112, 114, 116 appears to be fraudulent. In some exemplary embodiments, some or all of the above described checks, including a check for good standing, credit limit, fraud, etc. may be used to determine whether or not to authorize the transaction. In some exemplary embodiments, authorizing the transaction may include posting a debit in an amount equal to a cost of the transaction on the customer's account.

Process 400 may include a step 406 of determining whether the transaction is eligible for reward redemption. In one exemplary embodiment, eligibility may be determined by determining whether customer 112, 114, 116, initiating the transaction has enrolled in the rewards program and whether an account associated with customer 112, 114, 116 remains in good standing. Enrollment may be determined by inspecting the account associated with customer 112, 114, 116. For example, enrollment in the rewards program may be confirmed when the account includes a flag, indicator, or other marker indicating that the account is associated with the rewards program. In another exemplary embodiment, determining eligibility for award redemption may include determining whether an amount of the transaction is too high or too low relative to a threshold amount indicated by preferences associated with the rewards program, for example, preferences indicated in steps 308 and 310. For example, a transaction may not be eligible for reward redemption when the cost of the transaction exceeds a threshold amount such as one thousand dollars ($1000.00). In another exemplary embodiment, determining eligibility for award redemption may include determining the location where the transaction has been initiated. For example, a transaction may not be eligible for reward redemption when the transaction is related to a purchase of goods and/or services outside the United States, outside a particular merchant location, etc. In yet another exemplary embodiment, determining eligibility for award redemption may include determining whether the merchant or provider facilitating the transaction is one for whom the rewards program is available to the customer.

When it is determined that the transaction is not eligible for reward redemption (Step 406: NO), process 400 may end. When it is determined that the transaction is eligible for reward redemption (Step 406: YES), process 400 may proceed to a step 408 of issuing a credit notification to the customer. Issuing a credit notification may include communicating to customer 112, 114, 116 the cash value of the credit, the number of reward points, reward miles, and/or reward which may be deducted from the customer's reward balance, and the reward balance remaining after the deduction. The notification may be provided to customer 112, 114, 116 using any of the methods discussed above with respect to step 306 of process 300. In some exemplary embodiments, issuing the notification may also include updating a dashboard showing the cash value of the credit as applied to the transaction, the number of reward points, reward miles, and/or reward currency as deducted from the customer's reward balance, and the reward balance. The dashboard may be presented to customer 112, 114, 116 via textual or graphical information on a web page or may be sent to customer 112, 114, 116 via any of the notification methods discussed with respect to step 306 of process 300.

Process 400 may also include a step 410 of determining whether customer 112, 114, 116 has declined the credit. Determining whether customer 112, 114, 116 has declined the credit may be based on a response to a displayed cash value of the credit on a display 210 of, for example, customer system 102, 104, 106 or merchant system 122, 124 using information provided by server 140. Additionally or alternatively, in step 410, a cash value of the credit may be communicated to customer 112, 114, 116 using any of the methods of notification discussed with respect to step 306 of process 300. In some embodiments, customer 112, 114, 116 may be presented with an option to accept or decline the credit. In some exemplary embodiments, server 140 may provide the option to customer 112, 114, 116 via, for example, customer system 102, 104, 106. For example, server 140 may provide the notification while customer 112, 114, 116 is “checking out” at a merchant. In some exemplary embodiments, the option may be presented as a selectable button, a link, or other user interface feature in the notification displayed on display 210 or in the notification sent to customer 112, 114, 116. In other exemplary embodiments, the option to accept or decline the credit may be presented to customer 112, 114, 116 on a point-of-sale terminal of merchant system 122, 124 and merchant 132, 134 and/or customer 112, 114, 116 may have the option of selecting a button, link, or other user interface feature to accept or decline the credit. In some exemplary embodiments, customer 112, 114, 116 may have the option of responding to the notification within a specified time period, for example, 24 hours, 1 week, etc., to accept or decline the credit. When customer 112, 114, 116 does not decline the credit (Step 410: NO), process 400 may proceed to step 412. In other exemplary embodiments, when customer 112, 114, 116 fails to respond to the notification within the specified time period, process 400 may also proceed to step 412 of issuing a credit to the customer.

Issuing a credit may include determining a number of reward points, reward miles, and/or reward currency required to cover the cost of the transaction initiated by customer 112, 114, 116. Issuing a credit may also include posting a credit corresponding to the cost of the transaction to the account associated with customer 112, 114, 116. In some exemplary embodiments, issuing a credit may include debiting the cost of the transaction minus the credit from the customer's account. Issuing a credit may further include subtracting the number of reward points, reward miles, and/or reward currency required to cover the cost of the transaction from the reward balance associated with the customer's account.

Returning to step 410, when customer 112, 114, 116 decides to decline the credit (Step 410: YES), process 400 may end.

In some exemplary embodiments, when it is determined that the transaction is eligible for reward redemption (Step 406: YES), process 400 may automatically issue a credit according to the processes described above with respect to step 412 of process 400. Further, process 400 may issue a credit notification according to the processes described above with respect to step 408 after issuing the credit according to the processes described above with respect to step 412. If the customer declines the credit within a predetermined amount of time, process 400 may cancel the credit issued to the customer. Canceling the credit may include deducting the credit applied to the account associated with the customer. Canceling the credit may also include adding back the number of reward points, reward miles, and/or reward currency equivalent to the credit back to the customer's reward balance. Canceling the credit may also include sending a notification to customer 112, 114, 116 that reward benefits were not used towards the amount of the transaction. The notification may be sent to customer 112, 114, 116 using any of the notification methods discussed above with respect to step 306 of process 300. Process 400 may then end.

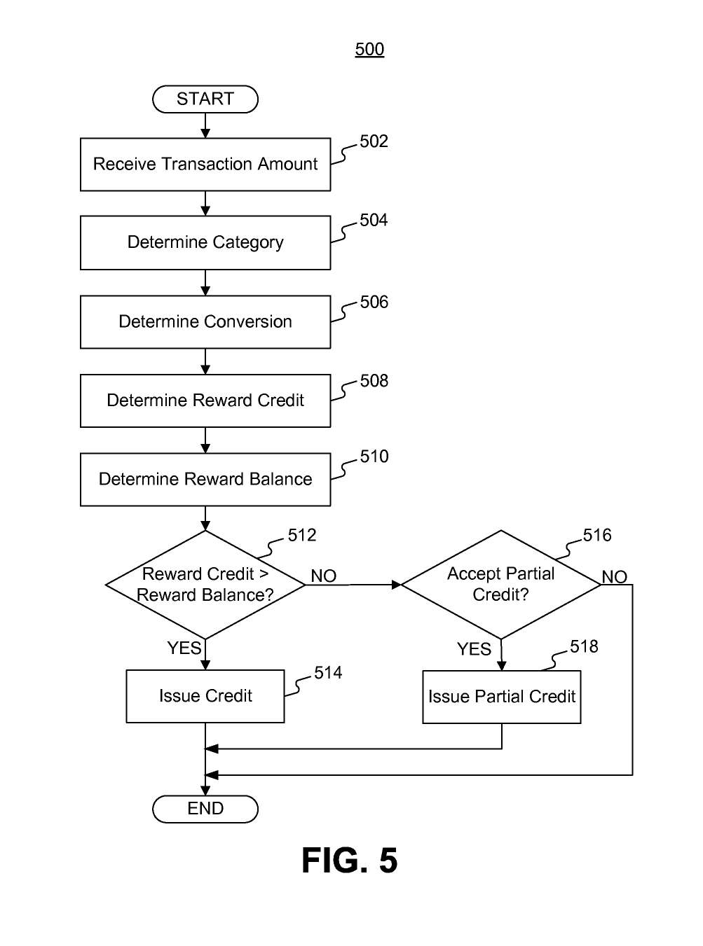

FIG. 5 is a flowchart of an exemplary process 500 that may be implemented for determining the number of reward points, reward miles, and/or reward currency that could be used to cover the cost of a transaction. Process 500 may be implemented on customer systems 102, 104, 106, merchant systems 122, 124, and/or server 140 communicating via network 130. The order and arrangement of steps in process 500 is provided for purposes of illustration. As will be appreciated from this disclosure, modifications may be made to process 500 by, for example, adding, combining, removing, and/or rearranging the steps for process 500.

Process 500 may include a step 502 of receiving the transaction amount. Receiving the transaction amount in step 502 may include accessing a cost of the transaction stored in database 150 or in another database associated with system 100. In some exemplary embodiments, receiving the transaction amount may include accessing the cost of the transaction amount stored in memory 206 or other storage medium 208. In other exemplary embodiments, the transaction amount may be received when a customer 112, 114, 116 or a merchant 132, 134 enters the cost of the transaction using one or more of the I/O devices 204. In some exemplary embodiments the transaction amount may be received when a customer 112, 114, 116 or a merchant 124, 134 scans a barcode associated with the goods or services using a barcode scanner. In some exemplary embodiments, the transaction amount may be included in a purchase transaction authorization requested by a merchant to a provider associated with the customer account used to make the purchase.

Process 500 may also include a step 504 of determining a category associated with the transaction. The category associated with the transaction may be determined based on a category associated with merchant system 122 or 124 or merchant 132, 134 providing the goods or services to the customer. For example, a category “coffee” may be associated with a transaction including purchase of coffee by a customer 112, 114, 116 or a transaction including making a purchase at a merchant 124, 134 associated with the category coffee. By way of another example, a category “travel” may be associated with purchase of an airline ticket by a customer 112, 114, 116 from a merchant system 122 or 124 or merchant 132, 134 who may provide travel related goods and services.

Process 500 may also include a step 506 of determining a conversion factor associated with the transaction. As used in this disclosure, a conversion factor may relate the reward points, reward miles, or reward currency to a cash value. In some exemplary embodiments, the conversion factor may be different for different categories. By way of example, the conversion factor for the category travel may be “100” indicating that 900 reward points or miles may correspond to a cash value of 9 dollars ($9). By way of another example, the conversion factor for the category “coffee” may be 50 indicating that 90 reward points or miles may correspond to a cash value of 4 dollars and 50 cents ($4.50).

Process 500 may include a step 508 of determining a reward amount. Determining the reward amount may include using the cost associated with the transaction and the conversion factor to determine a number of reward points, reward miles, or reward currency that correspond to the cost of the transaction. By way of example, when the conversion factor is 100, and a customer 112, 114, 116 purchases an airline ticket having a cost of $400, the reward amount (i.e. number of reward points, reward miles, or reward currency may be determined by multiplying the cost of $400 by the conversion 100 to obtain a reward amount of 40,000 reward points, reward miles, or reward currency.

Process 500 may also include a step 510 of determining the reward balance. Determining the reward balance may include inspection of the account associated with customer 112, 114, 116 to determine the number of reward points, reward miles, and/or reward currency that the customer may have accumulated. For example, a customer may have accumulated 50,000 reward points, reward miles, or reward currency making the value of the reward balance 50,000.

Process 500 may include a step 512 of determining whether the reward balance exceeds the reward amount determined, for example, in step 508. In one exemplary embodiment, the reward balance (i.e. the total number of reward points, reward miles, and/or reward currency associated with the customer's account) may be compared with the reward amount. In another exemplary embodiment, the reward balance may be converted into a cash value using the conversion factor associated with the transaction and the cash value may be compared with the cost of the transaction. When the reward balance exceeds the reward amount or when the cash value exceeds the cost of the transaction (Step 512: YES), process 500 may proceed to step 514 of issuing the credit. Issuing the credit may include using the processes discussed above with respect to step 408 of process 400. For example, when a customer purchases an airline ticket costing $400 as discussed in step 508 above, and has a reward balance of 50,000, a reward amount of 40,000 corresponding to the ticket price of $400 may be used. In this example, a credit of $400 may be posted to the account associated with the customer and 40,000 reward points, reward miles, or reward currency equal to the reward amount may be deducted from the customer's reward balance of 50,000 leaving the customer with a reward balance of 10,000. In some exemplary embodiments, issuing a credit may be transparent to the underlying merchant. For example, the merchant may receive the full transaction amount associated with the purchase from the provider associated with the customer account with no indication that the purchase was made using rewards points, reward miles, or reward currency of a rewards program associated with the customer's account. Process 500 may then end.

Returning to step 512, when it is determined that the reward balance does not exceed the reward amount or when the cash value does not exceed the cost of the transaction (Step 512: NO), process 500 may proceed to a step 516 of determining whether partial credit may be applied. Determining whether partial credit may be applied may include inspecting the account associated with customer 112, 114, 116 to determine the customer's preferences, for example, as indicated by a flag or other indicator, indicating that customer 112, 114, 116 has elected to use partial credit towards transactions. When it is determined that partial credit may be applied (Step 516: YES), process 500 may proceed to step 518 of issuing a partial credit.

Issuing a partial credit may include using the reward balance to fund at least a portion of the cost associated with the transaction. Issuing a partial credit may also include determining a partial cash value, which represents the portion of the cost, based on the reward balance and the conversion factor associated with the transaction. The process of issuing partial credit may be best illustrated by an example. Consider, for example, that the reward balance for a customer is 30,000 reward points, reward miles, and/or reward currency and that the customer purchases an airline ticket having a cost of $400 as discussed above with respect to step 508. If the conversion factor is 100, the reward amount needed to cover this transaction may be estimated by multiplying the cost of $400 by the conversion factor of 100, yielding 40,000 reward points, reward miles, or reward currency. Because the reward balance of 30,000 is less than the reward amount of 40,000, if partial credit is allowed, a partial reward amount of 30,000 reward points, reward miles, or reward currency may be applied towards the transaction. The partial cash value corresponding to the reward balance may be determined by dividing the reward balance (30,000) by the conversion factor (100), yielding a partial cash value of three-hundred dollars ($300). A partial credit of $300 may be issued and applied to the account associated with customer 112, 114, 116 leaving customer 112, 114, 116 with a liability of $100 for the purchase of the airline ticket. For example, while the airline may receive the full $400 purchase price, the customer's account may be debited (or charged) for only the $100 balance. At the same time, 30,000 reward points, reward miles, and/or reward currency may be deducted from the customer's reward balance of 30,000 leaving customer 112, 114, 116 with a reward balance of 0. Process 500 may then end. Returning to step 516, when it is determined that partial credit may not be accepted (Step 516: NO), process 500 may end without using any portion of the customer's reward balance to fund the transaction initiated by the customer.

Other embodiments of the disclosure will be apparent to those skilled in the art from consideration of the specification and practice of the embodiments disclosed herein. It is intended that the specification and examples be considered as exemplary only, with a true scope and spirit of the invention being indicated by the following claims.

What is claimed is:

1. A computer-implemented method for reward redemption, the method comprising:
receiving an indication that a customer initiated a transaction;
determining a cost of the transaction;
determining, by one or more processors, eligibility of the transaction for reward redemption; and
when the transaction is eligible:
determining a credit for an account associated with the customer;
debiting the cost of the transaction minus the credit from the account;
sending a notification to the customer regarding the credit; and
authorizing completion of the transaction.

2. The computer-implemented method of claim 1, further including:
accessing preferences associated with the account;
setting a cash value of the credit equal to the cost when the preferences indicate that reward benefits may be redeemed automatically; and
indicating the cash value to the customer in the notification.

3. The computer-implemented method of claim 1, further including:
accessing preferences associated with the account; and
when the preferences indicate that reward benefits may not be redeemed automatically:
sending a request for customer authorization to redeem reward benefits; and
receiving an indication that the customer wants to redeem reward benefits.

4. The computer-implemented method of claim 1,
wherein authorizing completion includes determining whether the account is in good standing, and
wherein determining eligibility of the transaction for reward redemption is based on the determination of good standing.

5. The computer-implemented method of claim 4, wherein determining whether the account is in good standing includes determining whether the account is overdue.

6. The computer-implemented method of claim 5, wherein determining whether the account is in good standing includes determining whether a flag indicative of fraud is associated with the account.

7. The computer-implemented method of claim 1, wherein determining eligibility includes:
determining whether the account is associated with a rewards program;
determining a reward amount corresponding to the cost associated with the transaction; and
determining whether a reward balance associated with the account exceeds the reward amount.

8. The computer-implemented method of claim 7, wherein the reward balance comprises reward points, reward miles, or reward currency.

9. The computer-implemented method of claim 7, wherein the credit:
equals the cost of the transaction when the reward balance exceeds the reward amount; and
equals a portion of the cost of the transaction when the reward balance is less than the reward amount.

10. The computer-implemented method of claim 9, further including subtracting a reward amount corresponding to the credit from the reward balance.

11. The computer-implemented method of claim 1, wherein determining the credit includes:
receiving a category corresponding to the transaction;
determining a conversion factor based on the category; and
determining the credit based on the cost and the conversion factor.

12. The computer-implemented method of claim 9, wherein determining the portion of the cost of the transaction includes:
receiving a category corresponding to the transaction;
determining a conversion factor based on the category; and
determining a cash value based on the reward balance and the conversion factor.

13. The computer-implemented method of claim 10, wherein sending a notification includes:
sending a communication indicating the credit to the customer;
debiting the reward balance with the reward amount; and
presenting, to the customer, a rewards dashboard indicating the reward balance.

14. The computer-implemented method of claim 1, wherein the transaction corresponds to a sale of goods or services.

15. A reward redemption system, comprising:
a database;
a memory storing instructions;
at least one processor configured to execute the instructions to perform operations comprising:
receiving an indication that a customer initiated a transaction;
determining a cost of the transaction;
accessing information for an account associated with a customer from the database;
determining eligibility of the transaction for reward redemption; and
when the transaction is eligible:
determining a credit for an account associated with the customer;
debiting the cost minus the credit from the account;
storing information related to the credit in the database;
sending a notification indicating the credit to the customer; and
authorizing completion of the transaction.

16. The reward redemption system of claim 15, wherein the at least one processor is further configured to execute the instructions to perform operations including:
accessing preferences associated with the account;
setting a cash value of the credit equal to the cost when the preferences indicate that reward benefits may be redeemed automatically; and
indicating the cash value to the customer in the notification.

17. The reward redemption system of claim 15,
wherein authorizing completion includes determining whether the account is in good standing, and
wherein determining eligibility of the transaction for reward redemption is based on the determination of good standing.

18. The reward redemption system of claim 15, wherein determining eligibility includes:
determining whether the account is associated with a rewards program;
determining a reward amount corresponding to the cost associated with the transaction; and
determining whether a reward balance associated with the account exceeds the reward amount.

19. The reward redemption system of claim 15, wherein determining the credit includes:
receiving a category corresponding to the transaction;
determining a conversion factor based on the category; and
determining the credit based on the cost and the conversion factor.

20. A non-transitory computer-readable medium storing instructions for creating a logo database that when executed by a processor, cause the computer to perform the steps of:
receiving an indication that a customer initiated a transaction;
determining a cost of the transaction;
determining eligibility of the transaction for reward redemption; and
when the transaction is eligible:
determining a credit for an account associated with the customer;
debiting the cost of the transaction minus the credit from the account;
sending a notification to the customer indicating the credit; and
authorizing completion of the transaction.
